(19) United States
(12) Patent Application Publication
(10) Pub. No.: US 2026/0034827 A1
(43) Pub. Date: Feb. 5, 2026

(54) SECURITY MARKER SYSTEM

(71) Applicant: METIS GLOBAL TRADING LIMITED, Leeds (GB)

(72) Inventors: STEPHEN CHARLES ROE, Coventry (GB); PAUL WARD, Coventry (GB)

(21) Appl. No.: 18/997,396

(22) PCT Filed: Jul. 20, 2023
(86) PCT No.: PCT/GB2023/051925

§ 371 Date: Jan. 21, 2025

(30) Foreign Application Priority Data
Jul. 20, 2022 (GB) 2210639.7

(51) Int. Cl. B42D 25/387; C09D 11/50

(52) U.S. Cl. CPC B42D 25/387; C09D 11/50

(57) ABSTRACT

A security or identification system including the application of two or more marker portions that include one or more compounds or mixture of compounds that fluoresce under exposure to electromagnetic radiation. The marker portions emit light at different wavelengths to each other when exposed to said electromagnetic radiation.

The invention to which this application relates is a forensic marker system that is used to verify contact and/or to securely verify the origin and/or originality of goods and services.

Although the following description refers exclusively to fluorescent markers that emit light due to ultraviolet (UV) radiation stimulation, the skilled person will appreciate that the present invention and markers included therein could be designed to fluoresce from stimulation of different wavelengths of electromagnetic radiation.

The use of ultraviolet (UV) marker pens to mark and identify valuables such as expensive goods and banknotes is known. For example, UV pens can be purchased to securely mark items of high value in case of theft. The ink of UV marker pens is fluorescent on exposure to UV light but transparent under normal lighting conditions.

A major disadvantage of conventional UV marking is however that markings can be easily altered or overwritten with UV pens and therefore, the authenticity of the marking can be challenged and/or the marking obliterated. As the UV ink in such pens is not unique, it is impossible to prove when, where and by whom the marking was made.

It is an aim of the present invention to provide a security marking system that addresses the abovementioned problems.

It is a further aim of the present invention to provide an improved method for the security marking of objects that addresses the abovementioned problems.

It is a yet further aim of the present invention to provide a composition combined with an apparatus to securely mark products that addresses the abovementioned problems.

In a first aspect of the invention there is provided a security or identification system including the application of two or more marker portions, said marker portions including one or more compounds or mixture of compounds that fluoresce under exposure to electromagnetic radiation characterised in that the marker portions emit light at different wavelengths to each other when exposed to said electromagnetic radiation.

Preferably the electromagnetic radiation is ultraviolet (UV) light or UV radiation. Typically, UV light has a wavelength from 10 nm to 400 nm. This is typically shorter than that of visible light, but longer than X-ray radiation. Further typically the UV light has a corresponding frequency of around 30 PHz to 750 THz.

Typically, the compounds that fluoresce under UV light are ultraviolet pigments. Further typically the UV pigments fluoresce at different wavelengths or fluoresce different colours on exposure to the UV light.

As such, the present invention uses of number of ultraviolet pigments with varying wavelengths and/or colour combinations to form a readable code when illuminated with UV lighting that is carried out in stages to validate and prove authenticity.

In one embodiment the marker portions comprise at least one UV fluorescent pigment dissolved or suspended in a carrier fluid. Typically, the marker portions include different UV fluorescent pigments and/or a different combination of UV fluorescent pigments.

In one embodiment the carrier fluid is a volatile liquid or fluid that evaporates or dries at or around room temperature. Typically following application to a surface, the carrier fluid dries or evaporates.

In one embodiment the carrier fluid is a gel and/or liquid polymer.

Typically, the UV fluorescent pigments are placed into a carrier fluid to form a sealant solution that is designed to be robust and form a bond on skin, hair, and/or fabrics such as clothing.

In an alternative embodiment the marker portions can be added to an existing liquid or fluid. Typically, the fluid is a petrochemical. Further typically the fluid is oil and/or refined oil products such as petroleum and/or the like.

In one embodiment the marker portions are applied to a surface as bands, stripes and/or lines. Typically, the bands, stripes or lines are adjacent and/or substantially parallel. Further typically the adjacent bands, stripes or lines contain different UV pigments and/or combination of different UV pigments.

In one embodiment the marker portions are applied as three or more bands, stripes or lines. Typically, the bands, stripes or lines contain different or UV fluorescent pigments or inks.

In one embodiment one or more of the marker portions may be blank wherein the portion does not contain a fluorescent pigment.

In one embodiment marker portions are applied to form one or more barcodes.

In one embodiment the marker portions and/or UV pigments are substantially invisible under daylight or normal lighting conditions. Typically, the marker portions or UV pigments contained therein fluorescent when illuminated by UV radiation such as that emitted by a black light or similar.

Further typically in the absence of UV light the marker portions are substantially undetectable.

In one embodiment the marker portions are substantially colourless and/or transparent until exposed to UV light.

In one embodiment the marker portions fluoresce different colours or do not fluoresce when exposed to different frequencies of UV light. Typically, different marker portions fluoresce different colours or do not fluoresce when exposed to UV-A (315-400 nm), UV-B (280-315 nm) and/or UV-C (200-280 nm) for example.

In one embodiment the system includes one or more polymer marker portions. Typically, the polymer marker portions contain one or more identification polymers. The polymer marker portion can optionally contain UV fluorescent pigments.

In one embodiment the identification polymers include unique or identifiable polymers, copolymers, block copolymers, DNA and/or RNA oligonucleotides.

In one embodiment the identification polymers include Molecular Imprinted Polymers (MIP).

Typically, the identification polymers are included in a carrying solution to form their own band, stripe or line located within the unique colour band. Typically, the identification polymers can be extracted and analysed separately to the UV pigments or bands.

In one embodiment the system includes at least on identifier target molecule. Typically, the identifier target molecule is not detectable by UV radiation. As such, other methods of analysis show the presence of the target identifier molecule.

In one embodiment of the invention the identification polymer and/or identifier target molecule can be detected using chromatographic separation. Typically, a swab is taken from one or more marker portions and dissolved or dispersed in a solvent. Further typically one or more reagents present on the chromatography stationary phase react with the identification polymer and/or identifier target molecule.

In a second aspect of the invention there is provided a method of marking objects, clothing and/or people with a security marker, said security marker including a plurality of marker portions or stripes wherein each marker portion or stripe fluoresces at a different frequency or colour, or does not fluoresce, when exposed to a specific frequency or range of frequencies of ultraviolet radiation.

In one embodiment at least some of the different marker portions or stripes fluoresce different colours or do not fluoresce when exposed to either UV-A, UV-B or UV-C.

In a third aspect of the invention there is provided an applicator apparatus to mark objects, clothing and/or people with a security marker, said security marker including a plurality of marker portions or stripes wherein each marker portion or stripe fluoresces at a different frequency or colour, or does not fluoresce, when exposed to a specific frequency or range of frequencies of ultraviolet radiation, wherein said apparatus includes at least one head or applicator portion that transfers or applies said marker portions or stripes to at least part of the objects, clothing and/or people.

Specific embodiments of the invention are now described with reference to the following figures wherein:

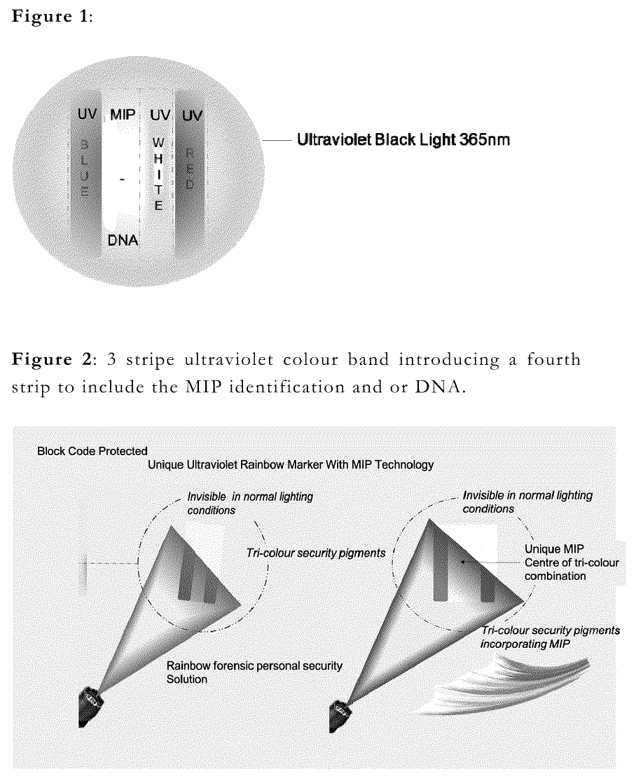

FIG. 1 shows a security mark illuminated with UV light according to one embodiment of the invention;

FIG. 2 shows an ultraviolet colour band with stripes in accordance with one embodiment of the invention;

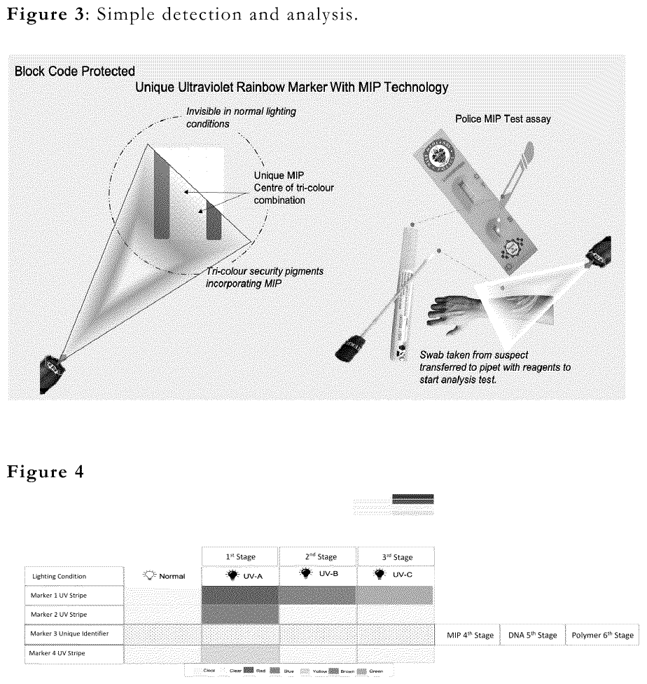

FIG. 3 illustrates a method of detection and analysis in accordance with one embodiment of the invention;

FIG. 4 illustrates how various bands or stripes fluoresce differently under different radiation frequencies;

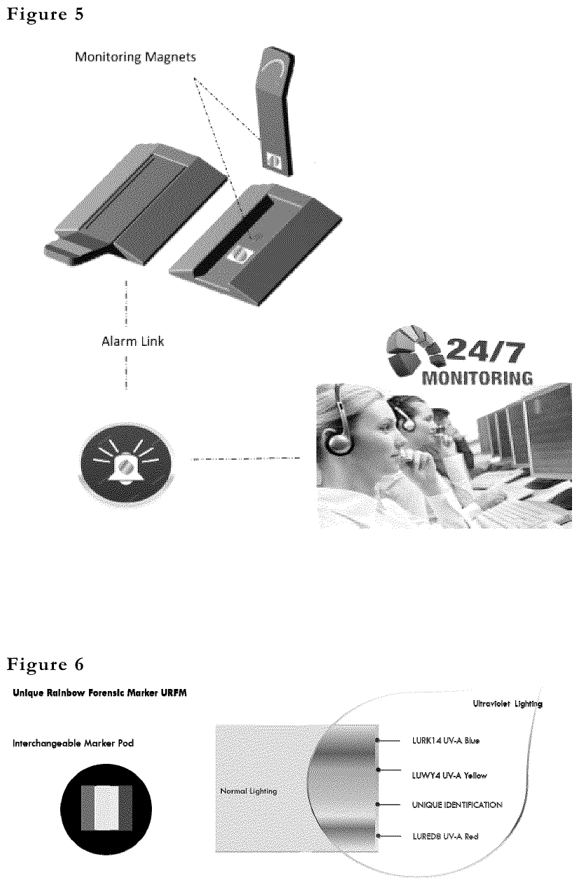

FIG. 5 shows a monitoring and marking system in accordance with one embodiment of the invention; and

FIG. 6 shows a security mark illuminated with UV light according to one embodiment of the invention.

The present invention concerns a Unique Rainbow Forensic Marker (URFM). URFM main advantages are its simplicity to apply, identify and recover by providing the missing link in the majority of security applications, “the ability to remove doubt” by providing a physical link that cannot be there by accident which gives the proof of presence at an incident helping to bring someone to account for their actions.

Forensic marking is not new to the security market, but the various technologies are over engineered, time consuming and costly limiting its use and not viable for the volume market.

URFM is different as it has been designed to fill the gap providing an efficient cost-effective solution that can be identified and analysed quickly giving confidence to proceed with any investigation with a support structure that aids prosecution.

The rainbow marker is a unique security product having an easy to implement fluorescent effect that is instantly recognisable that use a number of ultraviolet pigments with varying wavelengths and colour combinations to form a readable code with specialist lighting that is carried out in stages to validate and prove authenticity.

The mark is suspended in fluids to form barriers and protection against the elements whilst allowing transfer on contact, this allows for the marker stripes to be formed in varying shapes and sizes depending on the application. The ultraviolet pigments provide three stages of validation using different lighting frequencies.

In addition to the ultraviolet pigments further stages of validation can be introduced into and within the stripes to provide additional information and a higher level of security. These can include molecular imprinted polymers, uniquely coded oligonucleotides, aromatic molecules and a mixture of polymers and dyes.

Using ultraviolet pigments is not new and fairly standard in the industry but by assembling them in a unique way that can be used to provide coding is unique with the ability to visually identify and provide positioning for unique identifiers that can be extracted reliably and with confidence that can be analysed separately providing further tiers of validation using DNA, MIP and other volatiles to aid identification and prosecution.

Designing and developing pigments and unique DNA or MIP gives us the advantage to provide the complete package to support the Police Service and Criminal Prosecution with all the information in one place in the correct format.

The URFM will accompany any existing security devices raising the security level and deterrent. If an event occurs and the marker is deployed it will leave a unique colour pattern that will adhere to skin and clothing that is invisible to the naked eye but will show under black light 365 nm police standard issue.

Once the mark is detected the police can extract the unique identifier using normal extraction methods for independent analysis and or carry out their own analysis on the analysis paper supplied having the customers details and written statement of facts. The paper is unique allowing lateral flow chronography to extract the unique identifier from the sample taken from the suspect providing a positive or negative indication.

Having all the information in one place increases efficiency for the authorities and removes doubt therefore, potentially increasing the sentence imposed by the Court and consequently increasing the deterrent whilst providing justice and more protection for the vulnerable.

Turning to FIG. 1 where there is shown a security marker 2 comprising a number of marker portions or stripes 4a-4d. Each of the stripes are parallel, giving a barcode or rainbow effect when illuminated under a UV light. In the absence of sufficient UV electromagnetic stimulation, the stripes are not visible, for example under normal lights or daylight. In this example stripe 4a includes a pigment that fluoresces blue under a 365 nm UV Black Light. Stripe 4c fluoresces white under the same stimulation as it contains a number of pigments and stripe 4d fluoresces red. Stripe 4b does not contain a UV pigment, so appears as a space or gap between the stripes under the Black Light. FIG. 2 shows how the marker 2 is substantially invisible under normal lighting conditions or daylight and it is only when illuminated with UV-light (365 nm wavelength ‘blacklight’ in these examples) that the tri-colour strips become visible. The strip 4b in this example optionally includes a unique polymer that can be swabbed for and identified.

Optionally, the ‘blank’ stripe 4b can contain identification molecules such as the abovementioned polymers and including synthetic DNA and/or molecular imprinted polymers. In this example both identification molecules are present and can be detected through swabbing 6 and chromatographic analysis 8 as shown in FIG. 3.

FIG. 4 shows an example where four stripes are present and the verification or security check is performed by three stages of UV light exposure and potentially by the detection of molecular imprinted polymers, DNA, and a further polymer in a fourth, fifth and sixth stage respectively.

In this example, under the exposure to UV-A light the first stripe in the rainbow fluoresces red, the second blue and the fourth yellow. Under UV-B and UV-C radiation the second and fourth stripes do not fluoresce whilst the first stripe fluoresces brown/orange under UV-B and green under UV-C by the incorporation of the requisite UV active pigments.

As such, information can be encoded in the stripes and/or the presence of marking can be securely verified as there is no chance such stripes and polymer molecules could be present by chance. Unique stripe combinations can be employed along with bespoke polymer construction to provide a security mark that cannot be reproduced.

FIG. 5 gives an example of a static marker 10, in this case a panic station with a hand held stripe applicator 12. The small and discreet panic station has been designed to fit on or adjacent to a door frame, but also can be placed to provide protection in arears of vulnerability i.e. vehicle, outhouse, garages etc.

The panic station has a static fixed base that holds the unique rainbow marker 2 that is revealed by lifting a removable monitored section. The removeable section also holds a copy of unique rainbow marker providing flexibility and the ability to take the marker with you in an emergency or when retreating to a safe place.

The removable section is fastened centrally in place by magnetism for a secure fit whilst also monitoring its position, this can be also be linked to an alarm or tracking device via a simple interface that can be provided as an option if required.

The skilled person will appreciate that the base is not essential and the applicator unit or head could be incorporated into other objects, for example specialised jewellery; a key fob; a ring attachment for mobile phones, tablets etc.; a handheld atomizer; an attachment to a combined personal security alarm and tracker and a torch for UV and/or normal light.

The example given in FIG. 6 shows an embodiment with an interchangeable marker pad 102. This embodiment of a Unique Rainbow Forensic Marker (URFM) is made up from a number of ultraviolet security pigments 104a, 104b, 104d, suspended in a gel formulation that separates the pigmentation to form the unique rainbow stripe.

Each pigment is placed and mixed into a gel formulation that suspends and holds each pigment to a precise consistency to allow assembly and hold firm within its unique interchangeable housing for storage transportation and servicing.

In operation the unique formulation is used for protection against physical attack, the last line of defence whilst also providing a deterrent, when in fear of attack the user applies the mark to themselves by touching the URFM formulation that will then automatically transfer on contact.

The reason for the low rates for prosecution and the reluctance for authorities to follow up on physical attacks is the uncertainty and lack of evidence linking the suspect to the incident, the URFM mark removes this doubt providing accountability not only from the suspect but also the responding services.

Removing doubt, it will aid investigation and prosecution providing a meaningful deterrent and peace of mind leading to a safer environment to live in.

The simple instant visual identification is the 1st stage of verification and accountability this will be all that is required in 9 out of 10 cases, there are further stages of verification built into the design depending on the application that can be identified independently by any certified forensic laboratory following the Block Code standard procedures providing a belt and braces approach depending on the circumstances.

The unique identification in stripe 104c can be a unique polymer, oligonucleotide and/or trackable scent/fragrance. For example aniseed extract, Sulfurol, is described as having a meaty, brothy smell that is easily detected using chromatographic methods, gas-liquid chromatography in particular.

A pool of simplified molecules that can be identified singerly or collectively providing additional coding and levels of security to the UV fluorescent stripes.

1. A security or identification system including the application of two or more marker portions, said marker portions including one or more compounds or mixture of compounds that fluoresce under exposure to electromagnetic radiation characterised in that the marker portions emit light at different wavelengths to each other when exposed to said electromagnetic radiation.

2. A system according to claim 1 wherein the electromagnetic radiation is ultraviolet (UV) light or UV radiation.

3. A system according to claim 2 wherein the UV light has a wavelength from 10 nm to 400 nm.

4. A system according to claim 3 wherein the UV light has a corresponding frequency of around 30 PHz to 750 THz.

5. A system according to claim 2 wherein the compounds that fluoresce under UV light are ultraviolet pigments that fluoresce at different wavelengths or fluoresce different colours on exposure to the UV light.

6. A system according to claim 5 wherein the marker portions comprise at least one UV fluorescent pigment dissolved or suspended in a carrier fluid.

7. A system according to claim 6 wherein the carrier fluid is a volatile liquid or fluid that evaporates or dries at or around room temperature.

8. A system according to claim 7 wherein the carrier fluid is a gel and/or liquid polymer.

9. A system according to claim 6 wherein the marker portions are applied to a surface as bands, stripes and/or lines.

10. A system according to claim 9 wherein the bands, stripes or lines are adjacent and/or substantially parallel and the adjacent bands, stripes or lines contain different UV pigments and/or combination of different UV pigments.

11. A system according to claim 9 wherein the marker portions are applied as three or more bands, stripes or lines.

12. A system according to claim 11 wherein one or more of the marker portions may be blank wherein the portion does not contain a fluorescent pigment.

13. A system according to claim 12 wherein marker portions are applied to form one or more barcodes.

14. A system according to claim 12 wherein the marker portions and/or UV pigments are substantially invisible under daylight or normal lighting conditions and fluoresce when illuminated by UV radiation such as that emitted by a black light or similar.

15. A system according to claim 13 wherein the marker portions fluoresce different colours or do not fluoresce when exposed to different frequencies of UV light.

16. A system according to claim 14 wherein different marker portions fluoresce different colours or do not fluoresce when exposed to UV-A (315-400 nm), UV-B (280-315 nm) and/or UV-C (200-280 nm) for example.

17. A system according to claim 1 wherein the system includes one or more polymer marker portions containing one or more identification polymers and optionally UV fluorescent pigments.

18. A system according to claim 17 wherein the identification polymers include unique or identifiable polymers, copolymers, block copolymers, DNA and/or RNA oligonucleotides, and/or Molecular Imprinted Polymers (MIP).

19. (canceled)

20. A system according to claim 18 wherein the identification polymers are included in a carrying solution to form their own band, stripe or line located within the unique colour band.

21. A system according to claim 20 wherein the system includes at least one identifier target molecule, said identifier target molecule is not detectable by UV radiation.

22.-25. (canceled)
